(19) United States
(12) Patent Application Publication
(10) Pub. No.: US 2010/0247840 A1
(43) Pub. Date: Sep. 30, 2010

(54) PERMEABLE ANNULUS

(76) Inventors: Jason Mitchick, Royal Oak, MI (US); Mauricio Gonzalez-Rocha, Novi, MI (US)

Correspondence Address: Benita J. Rohm;Rohm & Monsanto, PLC, 12 Rathbone Place, Grosse Pointe, MI, 48230, US

(21) Appl. No.: 12/312,107

(22) PCT Filed: Oct. 24, 2007
(86) PCT No.: PCT/US07/22610

§ 371 Date: May 7, 2010

Related U.S. Application Data
(60) Provisional application No. 60/854,115, filed on Oct. 24, 2006.

(51) Int. Cl. B32B 3/00; B05D 1/18; B28B 1/54

(52) U.S. Cl. 428/71; 427/443.2; 264/134

(57) ABSTRACT

A process for making open-celled silicon carbide inserts (20) that allow metal infiltration to create metal-matrix composite part (100, 300) used for rubbing/wear components, such as an open-celled ceramic ring. The open-celled ceramic insert (20) is infiltrated by cast iron, and produces no negative effects to the iron casting process or the final metal-matrix composite product (100, 300) such as casting porosity or gas build-up inside the mold. Inserts (20) constructed in accordance with the invention enable manipulation and control over the density and weight of final metal-matrix composite products (100, 300). It is an advantageous characteristic of such inserts (20) that they enable manipulation and control over the dampening characteristics of final metal-matrix composite products (100, 300).

### RELATIONSHIP TO OTHER APPLICATION

This application claims the benefit of U.S. Provisional Patent Application Ser. No. 60/854,115 filed Oct. 24, 2006, the disclosure of which is incorporated herein by reference.

### BACKGROUND OF THE INVENTION

1. Field of the Invention

This invention relates generally to rubbing/wear components for vehicle braking systems, and more particularly, to a metal-matrix composite (“MMC”) component formed of a ceramic compound.

2. Description of the Related Art

For the past several decades previously ongoing research directed to the development of new gray iron alloys has significantly been slowed, largely due to developments in material science in the late 1950's, early 1960's. Gray cast iron is the material of choice for rubbing/wear components as a result of its advantageous wear resistance, machinability, and heat transfer properties. As such, this material is excellent for brake rotors, clutch plates, and other components in which wear characteristics are of significant concern.

It is an object of this invention to provide an open-celled ceramic ring or annulus using a simple and low cost method.

It is another object of this invention to provide a ceramic ring or annulus that can be infiltrated by cast iron.

It is also an object of this invention to provide a ceramic ring or annulus that produces no negative effects to the iron casting process or the final MMC product such as casting porosity or gas build-up inside the mold.

It is a further object of this invention to provide inserts that can manipulate and control the density and weight of final MMC products.

It is additionally an object of this invention to provide inserts that can manipulate and control the dampening characteristics of final MMC products.

It is still a further object of the invention to provide open-celled ceramic inserts for brake rotors and friction clutch plates to improve the overall performance of these components in tribology, thermal management, and noise, vibration, and harshness (“NVH”) properties.

### SUMMARY OF THE INVENTION

The foregoing and other objects are achieved by this invention which provides, in accordance with a method aspect, a method of forming a preformed insert for a cast part. The method includes the steps of:

forming a ceramic slurry compound; and

immersing an open cell structure into the ceramic slurry compound for coating the open-celled structure to form the preformed insert.

In one embodiment, the preformed insert is configured as an annulus or ring. In other embodiments, the preformed insert is a segment of an annulus.

In a further embodiment, there is further provided the step of casting the cast part, the step of casting the cast part including the further steps of:

depositing the preformed insert into a mold; and

infiltrating the preformed insert with molten metal.

Prior to performing the step of infiltrating the preformed insert with molten metal, there is provided the further step of affixing the preformed insert within the mold. In a further embodiment, there is provided the further step of locating the preformed insert within the mold to ensure that it is completely covered by the molten metal during the step of infiltrating the preformed insert with molten metal.

In further embodiments, there are provided the steps of reducing negative effects in an iron casting process or a metal-matrix composite product such as casting porosity or gas build-up inside the mold; manipulating and controlling the density and weight of a metal-matrix composite product; and manipulating and controlling the dampening characteristics of a metal-matrix composite product.

In an advantageous embodiment of the invention, the ceramic slurry compound comprises 50-90% Silicon Carbide with 10-50% Bentonite and 0-25% Silica. In other embodiments, however, the ceramic slurry compound may include 95-60% Silicon Carbide with 5-40% Calcium Aluminate; or 50-90% Silicon Carbide with 10-50% Fly Ash and 0-25% Silica; or 50-90% Silicon Carbide with 10-50% Rice Hull Ash and 0-25% Silica.

In accordance with a further aspect of the invention, there is provided a cast wear element having a ceramic preformed insert having a predetermined configuration and porosity. A volume of metal, such as gray iron, is arranged to infiltrate and substantially surround the ceramic preformed insert.

In one embodiment of this further aspect of the invention, the volume of metal is provided with a wear surface, and the ceramic preformed insert is disposed at a predetermined distance from the wear surface. In this manner, the ceramic preformed insert can be employed as a visual indicator of wear.

In an embodiment where the cast wear element is a rotatory wear element, the ceramic preformed insert is configured as an annulus. Alternatively, the ceramic preformed insert is configured as an arcuate segment of an annulus.

In accordance with a still further aspect of the invention, there is provided a rotatory cast wear element having a ceramic preformed insert having a predetermined configuration and porosity, the ceramic preformed insert being formed of an open-celled structure coated with a ceramic slurry compound that has been sintered. A volume of cast iron is arranged to infiltrate and substantially surround the ceramic preformed insert, the volume of cast iron having a wear surface.

In one embodiment of this further aspect of the invention, the ceramic preformed insert is disposed at a predetermined distance from the wear surface.

The invention provides a simple and low cost system and methodology for creating an open-celled ceramic insert, illustratively in the form of a ring or annulus. The open-celled ceramic insert readily can be infiltrated by cast iron, and produces no negative effects to the iron casting process or the final MMC product such as casting porosity or gas build-up inside the mold. In addition, inserts constructed in accordance with the invention enable manipulation and control over the density and weight of final MMC products. It is an advantageous characteristic of such inserts that the enable manipulation and control over the dampening characteristics of final MMC products.

It is recognized that the energy that is delivered into a given system must be released at the same or faster rate in order to continue the abruption of the energy to at the original rate. More specifically, if the release of the energy is performed at a slower rate than that at which the energy is input, energy saturation occurs resulting in NVH, thermal fractures, or disadvantageous tribological occurrences in the part. Accordingly, it is desired to increase the quantity of energy absorbed per unit time in cast iron pieces, while simultaneously improving performance in noise attenuation, as well as thermo-mechanical and tribological properties.

As indicated, in order to ensure that the open-celled ceramic inserts are completely encapsulated so that the full benefit of the present invention is achieved, it is desired in certain embodiments of the invention that the open-celled insert(s) are attached by (i) chemical or mechanical agents to the sand core, and (ii) a means that enables the molding machine to be oriented horizontally or vertically.

The final product is a cast part having an open-celled ceramic insert in its nucleus. In preferred embodiments, the open-celled insert is to be completely encapsulated by cast iron in the rubbing surfaces. However, in some embodiments, some exposure of the open-celled insert is permitted in non-rubbing surfaces.

In other embodiments, the open-celled ceramic insert is additionally useful as a wear indicator. Thus, when the open-celled ceramic insert is visible at the rubbing surfaces, this provides indication of advanced wear of the part, requiring replacement.

With the foregoing in mind, it is desired to achieve control over relative friction forces in wear/rubbing parts, the friction forces being modifiable on a the micro scale. Additionally, it is desired to increase the damping factor of such a cast part. This change in the properties of the cast part is achieved principally by controlling in the ratios of the ceramics in the slurry, the pores per linear inch, and the relative position of the open-celled silicon carbide inserts within the part infiltrated by the molten cast iron.

It is additionally desired to increase the thermo-mechanical properties of the material when the cast part is operated at high temperature, to achieve the benefits of increased tensile strength and heat conductivity of the material.

In application where weight is a consideration, the overall weight of the cast part, such as a brake disk rotor, from 8% to 15%. The weight reduction that is achieved will depend on the geometry of the part and where the open cell silicon carbide inserts are employed. Of course, it is additionally desired to increase the wear resistance of rubbing surfaces that are operated under extreme conditions, and to provide visual wear indication for rubbing surfaces.

### BRIEF DESCRIPTION OF THE DRAWING

Comprehension of the invention is facilitated by reading the following detailed description, in conjunction with the annexed drawing, in which

FIG. 1 is a representation of a ceramic slurry compound;

FIG. 2 is a representation of an open-celled structure bing inserted into the ceramic slurry compound;

FIG. 3 is a representation of a ceramic preform after sinterization;

FIG. 4 is a cross-sectional representation of a MMC rubbing/wear component constructed in accordance with the invention;

FIG. 5 is an enlarged representation of the ceramic preform showing its open cell configuration;

FIG. 6 is a representation of a portion of a brake disk rotor sand core for a mold showing ceramic preform segments thereon prior to the pouring of iron; and

FIGS. 7a and 7b are cross-sectional representations of a brake disk rotor constructed in accordance with the principles of the invention, FIG. 7a showing the braking surfaces portion of the brake disk rotor in cross-section, and FIG. 7b showing an enlarged portion of the brake disk rotor of FIG. 7a.

### DETAILED DESCRIPTION

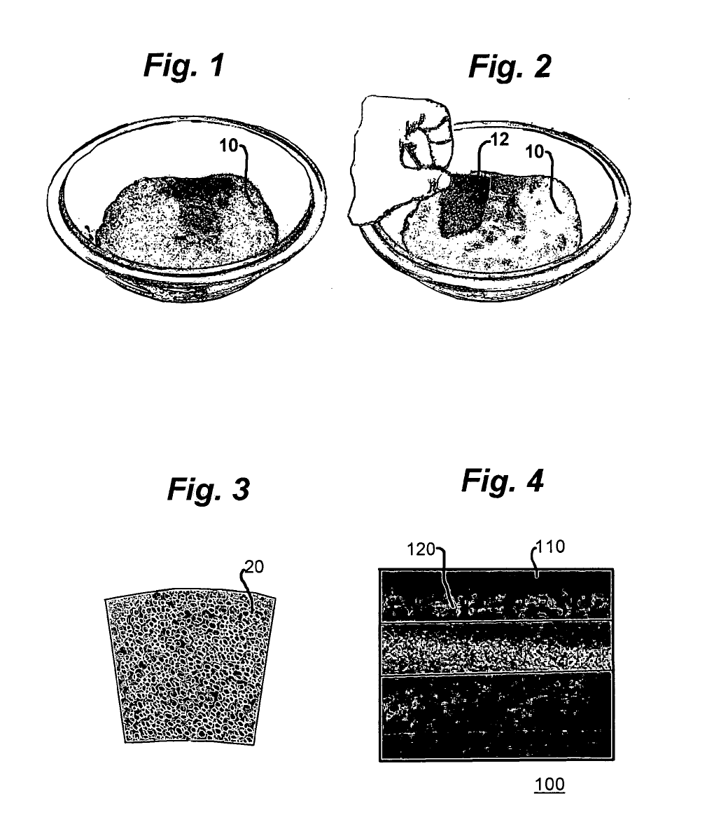

FIG. 1 is a representation of a ceramic slurry compound 10. As shown in this figure, the first step is to prepare a ceramic slurry compound. In this embodiment of the invention, slurry compound 10 is composed of Silicon Carbide powder with a combination with other powder materials, such as Bentonite, Calcium Aluminate, Fly Ash, Rice Hull Ash, and Silica. Some specifics regarding the slurry compound are described below. The dry powders are mixed with a liquefying agent that may include Colloidal Silica, Alkyl Aryl Amine Sulfonate, and water to produce the liquid slurry.

FIG. 2 is a representation of an open-celled structure 12 being inserted into ceramic slurry compound 10. In this step in the process of the invention, open-celled structure 12 is made of synthetic or natural organic material that is immersed into the ceramic slurry compound. In this specific illustrative embodiment of the invention, the open-celled structure is to be between 5-40 PPI (pores per inch). The immersion step is repeated until open-celled structure 12 is coated by ceramic slurry compound 10 to the desired coating thickness. After immersing the open-celled structure into the slurry compound, excess slurry compound that fills the pores is removed.

In one embodiment, the resulting coated element is configured as a coated ring that is then be heated in an oven (not shown) at approximately 80° C. to evaporate water or any other liquid contribution to the slurry. After the step of pre-heating of the insert is completed, the insert is then fired in a kiln (not shown) to sinter the slurry material that remains on the open-cell structure. This sintering process will also evaporate the original synthetic or natural organic open-celled structure leaving behind only the sintered open-celled ceramic insert. Firing temperatures can vary depending on the chemical composition from 1000° C. to 1600° C.

The inventors herein have found success with some of the following slurry mixture specifications:
50-90% Silicon Carbide; 10-50% Bentonite; 0-25% Silica
95-60% Silicon Carbide; 5-40% Calcium Aluminate
50-90% Silicon Carbide; 10-50% Fly Ash; 0-25% Silica
50-90% Silicon Carbide; 10-50% Rice Hull Ash; 0-25% Silica

Percentages of the above mixtures can vary and be changed to achieve different weights, strengths, porosity, and dampening characteristics of the final MMC product. Different mixture compositions can also be applied to different coats on the same insert to achieve different weights, strengths, porosity, and dampening characteristics of the final MMC product.

FIG. 3 is a representation of a ceramic preform 20 after sinterization. This figure shows the texture of the ceramic preform and its porosity.

FIG. 4 is a cross-sectional representation of a MMC rubbing/wear component constructed in accordance with the invention. As shown in this figure, a cast part 100, illustratively a rotatory cast part in the form of a brake disc rotor, is formed of an iron component 110 that has been cast to surround and infiltrate a ceramic preform 120. The ceramic preform may be configured as a ring that is installed in the mold (not shown) prior to the pouring of the iron. In other embodiments, however, the ceramic preform may be configured as a plurality of arcuate segments (not shown) that are installed concentrically within the mold prior to the pouring of the iron.

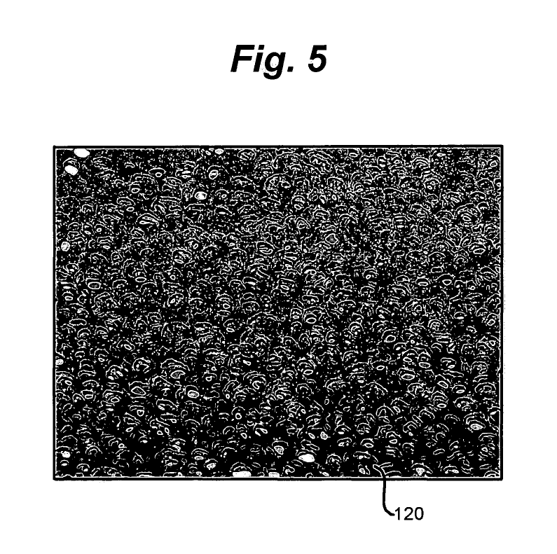

FIG. 5 is an enlarged representation of the ceramic preform 120 showing its open cell structure and configuration. As indicated, the thickness of the slurry coating will determine the pore sizing of the resulting insert.

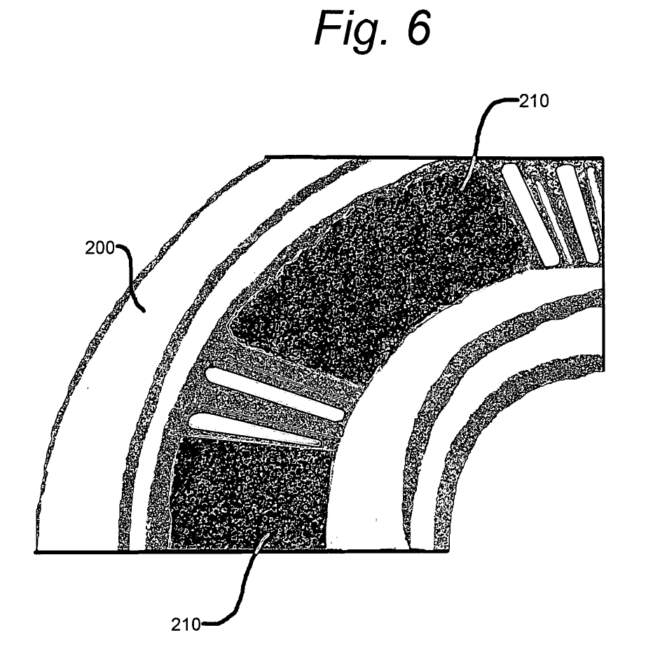

FIG. 6 is a representation of a portion of a brake disk rotor sand core 200 for use in a mold (not shown), and further showing several ceramic preform segments 210 thereon prior to the pouring of iron (not shown in this figure). Brake disk rotor sand core 200 is of the type that is used in the manufacture of brake disk rotors to form the voided region between the parallel concentric braking plates (not shown). During the pouring of the molten iron, preform segments 210 are held in place illustratively by small deposits of a suitable adhesive (not shown), such as CORFIX 10 adhesive that is available commercially from Foseco Metallurgical, Inc. In some embodiments, preform segments 210 are affixed to, and raised off of, the sand core to ensure that the preform segments are completely encased within the poured iron.

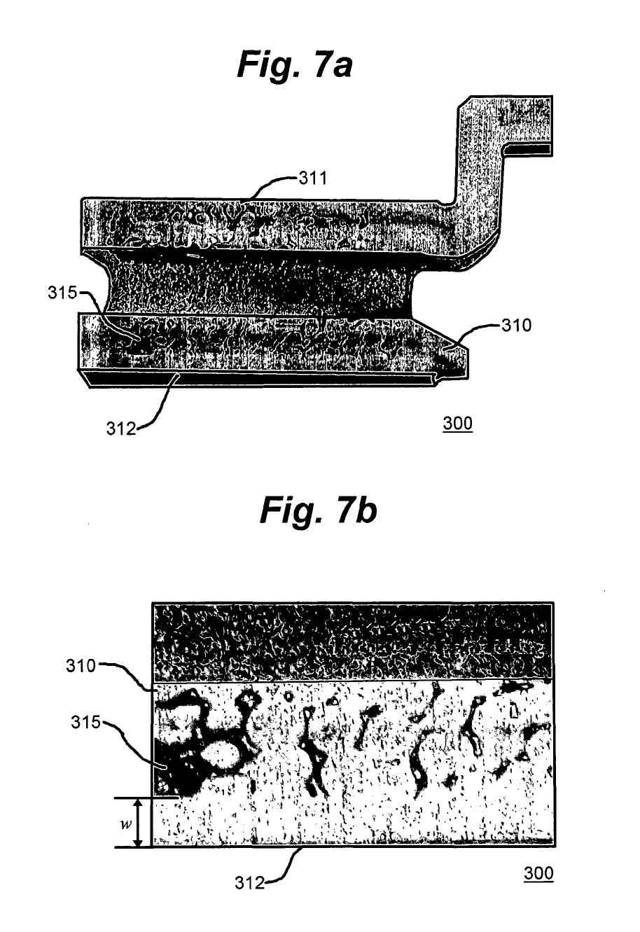

FIGS. 7a and 7b are cross-sectional representations of a brake disk rotor 300 constructed in accordance with the principles of the invention. FIG. 7a shows brake disk rotor 300 to have a braking plates 310 and 311. Brake plate 310 has, in this embodiment, a machined braking surface 312. In addition, this figure shows an embedded ceramic preform 315 encapsulated within the casing.

FIG. 7b shows an enlarged portion of the brake disk rotor of FIG. 7a, specifically braking plate 310 and braking surface 312. Elements of structure that have previously been discussed are similarly designated in this figure. In this specific illustrative embodiment of the invention, it is seen that embedded ceramic preform 315 is embedded so as to be inwardly away from braking surface 312 by a distance w. Thus, after such use that braking plate 310 is worn through the distance w, embedded ceramic preform 315 will be visible on the braking surface, thereby serving as a wear indicator.

Although the invention has been described in terms of specific embodiments and applications, persons skilled in the art may, in light of this teaching, generate additional embodiments without exceeding the scope or departing from the spirit of the invention described herein. Accordingly, it is to be understood that the drawing and description in this disclosure are proffered to facilitate comprehension of the invention, and should not be construed to limit the scope thereof.

What is claimed is:

1. A method of forming a preformed insert for a cast part, the method comprising the steps of:
forming a ceramic slurry compound; and
immersing an open cell structure into the ceramic slurry compound for coating the open-celled structure to form the preformed insert.

2. The method of claim 1, wherein the preformed insert is configured as an annulus.

3. The method of claim 1, wherein the preformed insert is configured as a segment of an annulus.

4. The method of claim 1, wherein there is further provided the step of casting the cast part, said step of casting the cast part comprising the further steps of:
depositing the preformed insert into a mold; and
infiltrating the preformed insert with molten metal.

5. The method of claim 4, wherein prior to performing said step of infiltrating the preformed insert with molten metal, there is provided the further step of affixing the preformed insert within the mold.

6. The method of claim 4, wherein prior to performing said step of infiltrating the preformed insert with molten metal, there is provided the further step of locating the preformed insert within the mold to ensure that it is completely covered by the molten metal during said step of infiltrating the preformed insert with molten metal.

7. The method of claim 1, wherein there is further provided the step of reducing negative effects in an iron casting process or a metal-matrix composite product such as casting porosity or gas build-up inside the mold.

8. The method of claim 1, wherein there is further provided the step of manipulating and controlling the density and weight of a metal-matrix composite product.

9. The method of claim 1, wherein there is further provided the step of manipulating and controlling dampening characteristics of a metal-matrix composite product.

10. The method of claim 1, wherein the ceramic slurry compound comprises 50-90% Silicon Carbide; 10-50% Bentonite; 0-25% Silica.

11. The method of claim 1, wherein the ceramic slurry compound comprises 95-60% Silicon Carbide; 5-40% Calcium Aluminate.

12. The method of claim 1, wherein the ceramic slurry compound comprises 50-90% Silicon Carbide; 10-50% Fly Ash; 0-25% Silica.

13. The method of claim 1, wherein the ceramic slurry compound comprises 50-90% Silicon Carbide; 10-50% Rice Hull Ash; 0-25% Silica.

14. A cast wear element comprising:
a ceramic preformed insert having a predetermined configuration and porosity; and
a volume of metal arranged to infiltrate and substantially surround said ceramic preformed insert.

15. The cast wear element of claim 14, wherein said volume of metal is provided with a wear surface.

16. The cast wear element of claim 15, wherein said ceramic preformed insert is disposed at a predetermined distance from the wear surface.

17. The cast wear element of claim 14, wherein the cast wear element is a rotatory wear element, and said ceramic preformed insert is configured as an annulus.

18. The cast wear element of claim 14, wherein the cast wear element is a rotatory wear element, and said ceramic preformed insert is configured as an arcuate segment of an annulus.

19. A rotatory cast wear element comprising:
a ceramic preformed insert having a predetermined configuration and porosity, said ceramic preformed insert being formed of an open-celled structure coated with a ceramic slurry compound that has been sintered; and
a volume of cast iron arranged to infiltrate and substantially surround said ceramic preformed insert, said volume of cast iron having a wear surface.

20. The rotatory cast wear element of claim 19, wherein said ceramic preformed insert is disposed at a predetermined distance from the wear surface.
